(19) United States
(12) Patent Application Publication
(10) Pub. No.: US 2012/0307301 A1
(43) Pub. Date: Dec. 6, 2012

(54) NON-TRANSITORY COMPUTER READABLE RECORDING MEDIUM STORED WITH PRINT JOB DISPLAY PROGRAM AND PRINT JOB DISPLAY APPARATUS

(75) Inventors: Tomoko OTOMARU, Tokyo (JP); Kazuto YAMAMOTO, Tokyo (JP)

(73) Assignee: KONICA MINOLTA BUSINESS TECHNOLOGIES, INC., Tokyo (JP)

(21) Appl. No.: 13/483,786

(22) Filed: May 30, 2012

(30) Foreign Application Priority Data
Jun. 2, 2011 (JP) 2011-124485

(51) Int. Cl. G06K 15/02

(52) U.S. Cl. 358/1.15

(57) ABSTRACT

The non-transitory computer readable recording medium of the present invention is a computer readable recording medium stored with a print job display program, and this program causes a computer to execute the steps of: (a) identifying a print job designating variable printing; and (b) displaying, on a display screen in a list, information related to the print job, to which information related to a plurality of sub-jobs obtained by classifying the information of the identified print job based on predetermined classification information is attached as lower layer information, with information related to a print job not designating variable printing.

### CROSS-REFERENCE TO RELATED APPLICATION

This application is based on Japanese Patent Application No. 2011-124485 filed on Jun. 2, 2011, the contents of which are incorporated herein by reference.

### BACKGROUND

1. Technical Field

The present invention relates to a non-transitory computer readable recording medium stored with a print job display program and a print job display apparatus for displaying a list of print jobs on a display screen.

2. Description of Related Art

Variable printing is known as a printing technology intended for volume printing. Variable printing refers to printing in which the output content of every one page can be partially changed according to need. An image forming apparatus such as an MFP (Multi-Function Peripheral) executes variable printing upon receiving a print job which designates variable printing.

Now, a general image forming apparatus has a function for displaying a list of received print jobs on an operation panel. Given this function, by referencing the information of print jobs displayed in a list on the operation panel, the user is able to know the print jobs having been received in the image forming apparatus.

However, in the event the image forming apparatus has received a print job which designates variable printing and a regular print job not designating variable printing, information of the print job which designates variable printing and information of the regular print job not designating variable printing are displayed likewise on the operation panel, and the user is unable to identify the print job which designates variable printing in the list of print jobs. In the event information of a print job which designates variable printing and information of a regular print job are displayed in a list, the information of the print job which designates variable printing is preferably displayed to be distinguishable from the information of the regular print job.

Note that Japanese Patent Application Laid-Open No. 2010-218306 discloses a technology for displaying a list of print jobs which designate variable printing on a per record basis. However, this is simply a technology for displaying information of print jobs which designate variable printing, and displaying information of print jobs which designate variable printing and information of regular print jobs in a list is not considered therein.

### SUMMARY

The present invention is made in view of the above-described problems. It is therefore an object of the present invention to provide a non-transitory computer readable recording medium stored with a print job display program and a print job display apparatus, which improve user friendliness by allowing, when information of a print job which designates variable printing and information of a print job not designating variable printing are displayed in a list, the user to identify the information of the print job which designates variable printing and easily determine whether a print job is a print job that designates variable printing or a print job that does not designate variable printing.

To achieve at least one of the above-mentioned objects, a non-transitory computer readable recording medium reflecting one aspect of the present invention is a computer readable recording medium stored with a print job display program, and this program causes a computer to execute a process comprising: (a) identifying a print job designating variable printing, in which printing is carried out while replacing part of printing content; and (b) displaying, on a display screen in a list, information related to the print job, to which information related to a plurality of sub-jobs obtained by classifying the information of the print job identified in step (a) based on predetermined classification information is attached as lower layer information, with information related to a print job not designating variable printing.

In the above-described non-transitory computer readable recording medium, the display screen is preferably configured to be able to switch between an open state in which the information related to the sub-jobs is displayed with the information related to the print job designating variable printing, and a folded state in which the information related to the sub-jobs is not displayed and the information related to the print job designating variable printing is displayed.

In the above-described non-transitory computer readable recording medium, the information related to the sub-jobs preferably includes status information to show the status of the sub-jobs, and the display screen preferably displays the status information for each of the plurality of sub-jobs in a list.

In the above-described non-transitory computer readable recording medium, the information related to the sub-jobs preferably includes printing setting information to represent printing setting set for the sub-jobs, and the display screen preferably displays the printing setting information for each of the plurality of sub-jobs in a list.

In the above-described non-transitory computer readable recording medium, the information related to the print job designating variable printing preferably includes information that corresponds to the information related to the sub-jobs, and the display screen preferably displays the information corresponding to the information related to the sub-jobs in association with identification information of the print job designating variable printing.

In the above-described non-transitory computer readable recording medium, in an event where values of the information related to the sub-jobs vary between the plurality of sub-jobs, the information related to the print job designating variable printing preferably includes at least one of the values that vary between the sub-jobs, and the display screen preferably displays the at least one value.

In the above-described non-transitory computer readable recording medium, information for letting a user know that the values of the information related to the sub-jobs vary between the plurality of sub-jobs is preferably added to the information related to the print job designating variable printing, and the display screen preferably displays the information for letting the user know that the values vary between the plurality of sub-jobs.

In the above-described non-transitory computer readable recording medium, the information related to the sub-jobs preferably includes print page-number information to represent the number of pages to print for the sub-jobs, and the information related to the print job designating variable printing preferably includes total page-number information to represent a total number of pages to print for the plurality of sub-jobs, and the display screen preferably displays the print page-number information for each of the plurality of sub-jobs in a list, and displays the total page-number information in association with identification information of the print job designating variable printing.

In the above-described non-transitory computer readable recording medium, the process preferably further comprises: (c) in an event the information related to the sub-jobs is not displayed and the information related to the print job designating variable printing is displayed on the display screen, displaying the information related to the sub-jobs on a separate screen according to an operation by a user.

In the above-described non-transitory computer readable recording medium, the information related to the print job not designating variable printing preferably includes same information as the information related to the sub-jobs, and the display screen preferably displays the same information in association with identification information of the print job not designating variable printing.

The objects, features, and characteristics of this invention other than those set forth above will become apparent from the description given herein below with reference to preferred embodiments illustrated in the accompanying drawings.

### BRIEF DESCRIPTION OF THE DRAWINGS

FIG. 1 is a block diagram showing an overall structure of a printing system according to an embodiment of the present invention.

FIG. 2 is a block diagram showing a structure of the PC shown in FIG. 1.

FIG. 3 is a schematic front view showing a structure of the MFP shown in FIG. 1.

FIG. 4 is a block diagram showing a structure of the MFP shown in FIG. 1.

FIG. 5 is a view showing an example of print data for variable printing.

FIG. 6 is a view showing an example of a print job list display screen.

FIG. 7 is a view showing an example of a print job list display screen.

FIG. 8 is a view for explaining a state in which all information of the variable print job displayed on a print job list display screen is opened up.

FIG. 9A and FIG. 9B are partial enlarged views of FIG. 8.

FIG. 10 is a view showing an example of a display screen in the event status information that is included in lower layer information of a variable print job is displayed in a popup on a display screen.

FIG. 11 is a view showing an example of a display screen in the event lower layer information of a variable print job is displayed on a separate screen.

FIG. 12 is a flowchart showing the steps of a printing process executed by an MFP.

FIG. 13 is a flowchart showing the steps of the job list display process shown in step S104, S107 and S109 in FIG. 12.

### DETAILED DESCRIPTION

The embodiments of this invention will be described below with reference to the accompanying drawings.

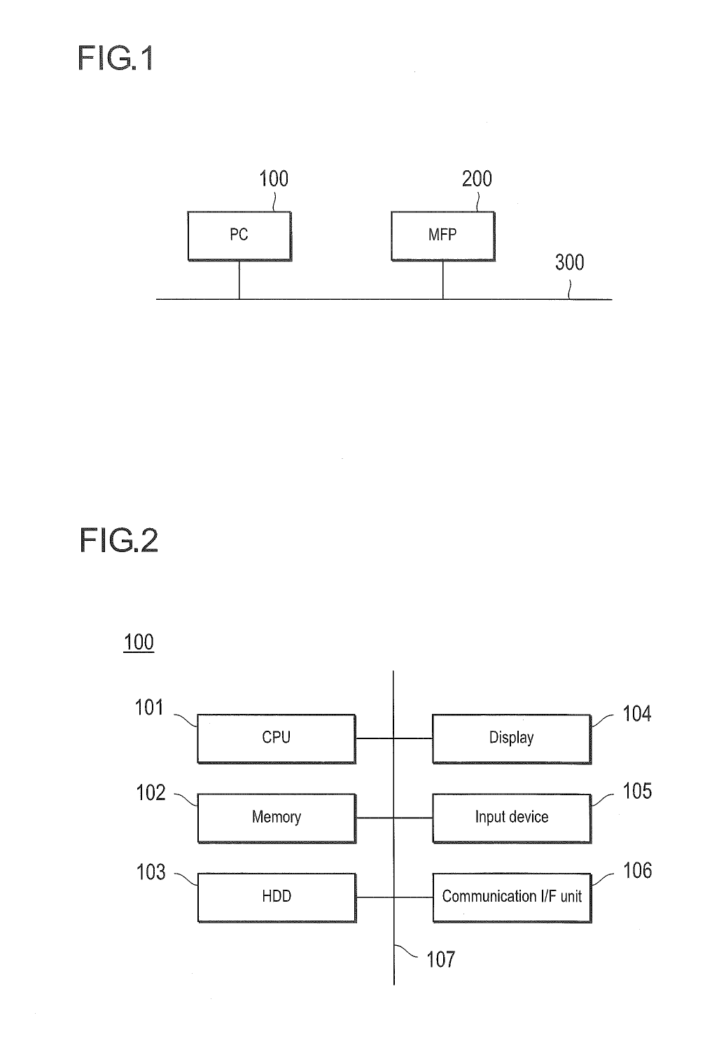

FIG. 1 is a block diagram showing an overall structure of a printing system according to an embodiment of the present invention.

The printing system of the present embodiment includes a PC (Personal Computer) 100, which serves as a print job transmitting apparatus, and an MFP 200, which serves as a print job display apparatus, and these are connected to be able to communicate with each other via a network 300. The network 300 is formed with, for example, a LAN (Local Area Network) which connects computers and network devices based on a standard such as Ethernet, TokenRing, and FDDI (Fiber Distributed Data Interface), and a WAN (Wide Area Network) which connects LANs by dedicated cables. Note that the types and number of devices to be connected with the network 300 are not limited by the example illustrated in FIG. 1. Also, the PC 100 and MFP 200 may be connected directly between devices (i.e. local connection), without involving the network 300.

FIG. 2 is a block diagram showing a structure of the PC shown in FIG. 1. The PC 100 includes a CPU (Central Processing Unit) 101, a memory 102, an HDD (Hard Disk Drive) 103, a display 104, an input device 105, and a communication I/F (Interface) unit 106, and these are connected with each other via a bus 107 for exchanging signals.

The CPU 101 controls the above-described units and performs various operation processes according to programs. The memory 102 comprises, for example, a ROM (Read Only Memory) that stores various programs and various data in advance, and a RAM (Random Access Memory) that stores programs and data on a temporary basis as a work space.

The HDD 103 stores various programs and various data, including the operating system. A document file making application for making document files and a printer driver for converting document files into print data described in a page description language (PDL) which the MFP 200 can interpret, are installed in the HDD 103. The document file making application includes an application for variable printing.

The display 104 is, for example, a liquid crystal display, and displays various information. The input device 105 includes a pointing device such as a mouse and a keyboard, and is used for enabling various inputs.

The communication I/F unit 106 is an interface for communicating with other devices via the network 300, and adopts a standard such as Ethernet, TokenRing, and FDDI.

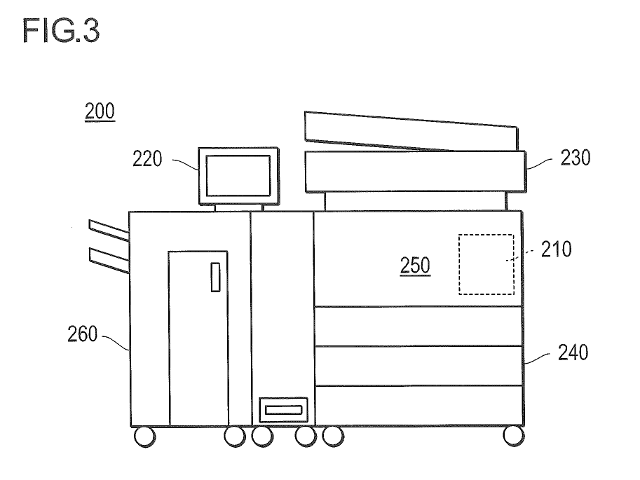

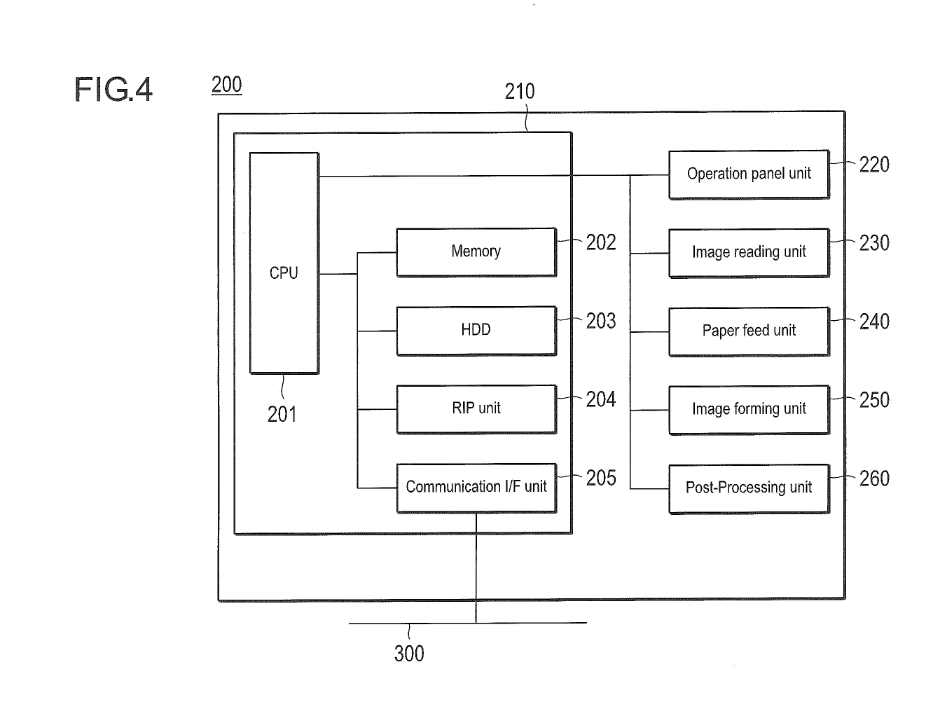

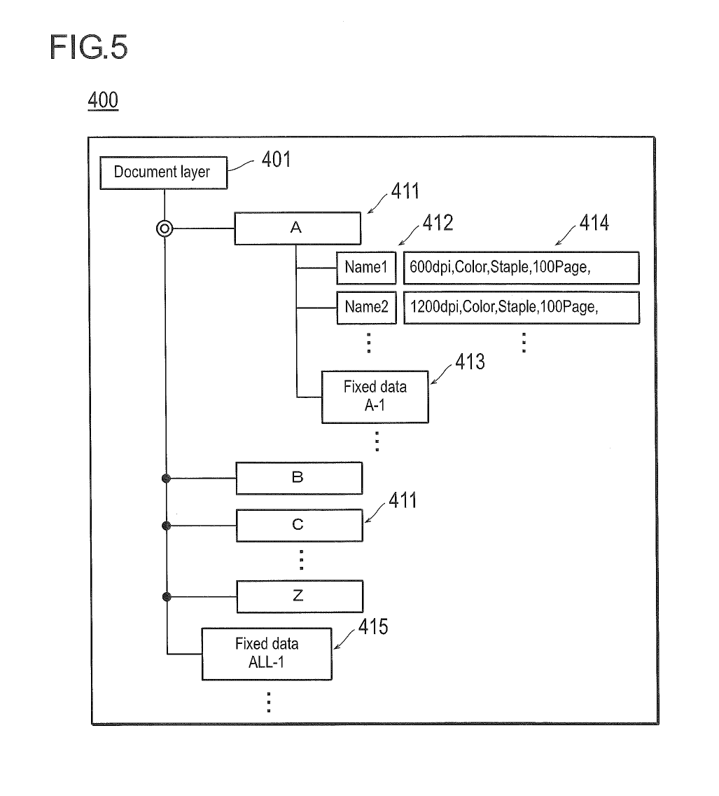

FIG. 3 is a schematic front view showing a structure of the MFP shown in FIG. 1, and FIG. 4 is a block diagram showing a structure of the MFP shown in FIG. 1.

The MFP 200 includes a control unit 210, an operation panel unit 220, an image reading unit 230, a paper feed unit 240, an image forming unit 250, and a post-processing unit 260, and these are connected with each other via a bus for exchanging signals. Note that, amongst the above units of the MFP 200, units that have the same functions as the units of the PC 100 will not be explained to avoid redundant explanations.

The control unit 210 includes a CPU 201, a memory 202, an HDD 203, an RIP unit 204 and a communication I/F unit 205. The HDD 203 stores a program for displaying, in a list, the print jobs stored in the memory 202.

The RIP unit 204 converts print data from the PC 100 to generate image data in bitmap format.

The operation panel unit 220 has, for example, a touch panel, ten-keys, a start button and a stop button, and is used to display various information and input various commands.

The image reading unit 230 illuminates the document that is set in a predetermined reading position or document that is transported to a predetermined reading position by an ADF (Auto Document Feeder), by a light source such as a fluorescent lamp, performs an opto-electronic conversion of the reflected light by an imaging device such as a CCD (Charge Coupled Device) image sensor, and generates image data from the electrical signals.

The paper feed unit 240 accommodates paper as a recording medium to be used for printing. The paper feed unit 240 has a plurality of paper feed trays and sends out the paper accommodated in the paper feed trays one sheet at a time.

The image forming unit 250 forms images on paper based on various data, using known imaging processes such as electronic photographic processes including the steps of electrical charging, exposure, developing, transferring and fixing.

The post-processing unit 260 discharges paper on which images have been formed by the image forming unit 250. The post-processing unit 260 has a plurality of discharge trays, and paper on which images have been formed is discharged to the discharge trays. Also, the post-processing unit 260 is provided with post-processing devices (not shown) for applying post-processing including a stapling process, a punching process and a perfect binding process, and is able to apply post-processing to printed paper according to the printing settings.

Note that the PC 100 and the MFP 200 both may include components other than the above components and may not include part of the above components.

Next, referring to FIG. 5, variable printing that is executed by the printing system of the present embodiment will be described. Variable printing according to the present embodiment is executed using PDF/VT (Portable Document Format/Variable Transactional). Variable printing is used to make, for example, direct mail and catalogues that are customized per customer.

FIG. 5 is a view showing an example of print data for variable printing. Print data 400 for variable printing has a data structure that is defined by PDF/VT.

As shown in FIG. 5, the print data 400 has a layered structure. The document layer 401 exists as the root of the layered structure, and, in this, meta data is classified and included in a layered structure.

To be more specific, this is a layered structure in which the categories 411 exist under the document layer 401, which is the root, and, underneath this, variable data 412 and fixed data 413 exist. The variable data 412 is attached a job ticket 414, which specifies in which printing format each variable data is to be printed. Fixed data 415, which is not included in the categories, also exists right underneath the document layer 401.

The categories 411 are data for classifying variable data. The categories 411 are, for example, classification based on the postal code, classification per product, classification per customer age, and can be defined flexibly. To be more specific, for example, in a specific month, categorization is carried out on a per postal code basis so as to send direct mail to around a specific area, and, in another month, categorization is carried out on a per product basis so as to place the focus of sales promotion on a specific product. Then, upon printing, it is possible to transmit one print job per category 411 to the MFP 200, or transmit a plurality of categories 411 together.

The variable data 412 is data that is replaced in a print job. The variable data 412 defines, for example, personal information such as the customer's name, address, postal code, age, income level, and which fixed data is used in association therewith. Also, the variable data 412 includes structural information as to in which place on each page each variable data is to be placed. Also, the variable data 412 is attached a job ticket 414, which specifies in which printing format that data is to be printed. To be more specific, information about, for example, the resolution, color printing, post-processing and the number of pages to print upon printing data for a specific client name, is attached.

The fixed data 413 is data that is recycled in a print job and is also referred to as “form data.” The fixed data 413 includes, for example, product photograph data, barcode data. Also, the fixed data 413 includes hint information, which shows, for example, whether or not that fixed data is recycled, whether or not that fixed data is recycled over a plurality of pages, and whether or not that fixed data is used in a plurality of print jobs. A plurality of fixed data 413 can be defined in one category 411.

The fixed data 415 that is not classified in the categories 411 is, for example, data (images, words, etc.) that is used in common over a plurality of categories 411.

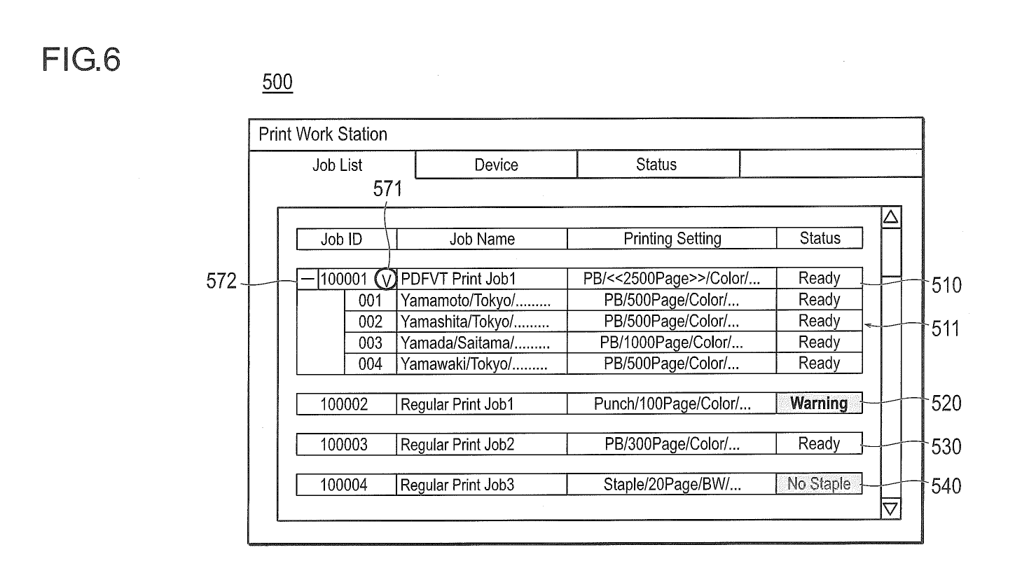

Next, referring to FIG. 6 to FIG. 11, the print job list display screen that is displayed on the operation panel unit 220 of the MFP 200 will be explained.

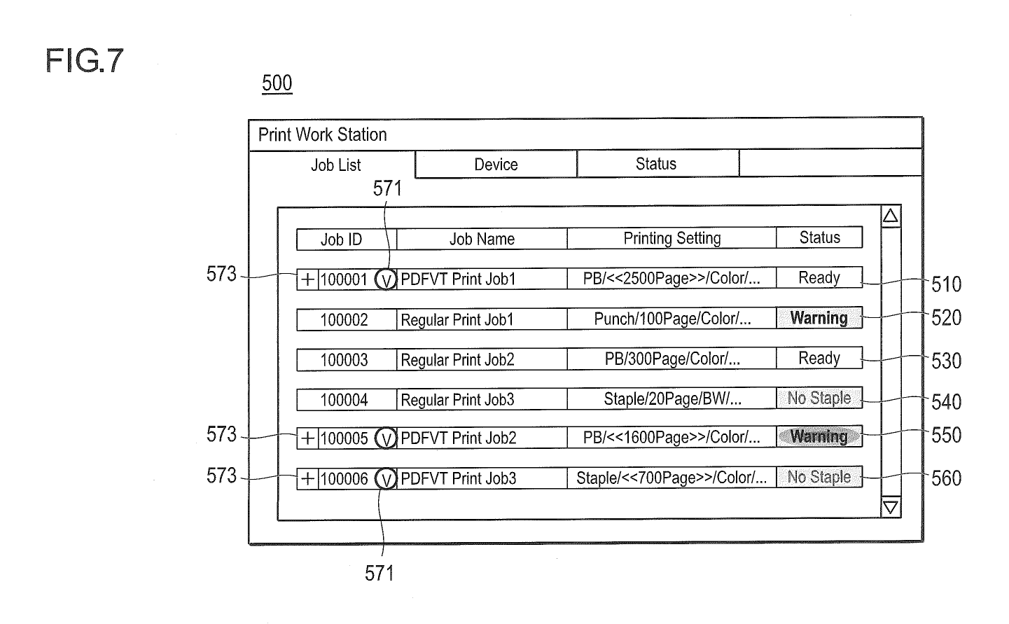

FIG. 6 and FIG. 7 are views showing examples of a print job list display screen. The print job list display screen 500 places information of a print job which designates variable printing (hereinafter referred to as “variable print job”) in a layered structure, and displays this with information of the regular print job which does not designate variable printing (hereinafter referred to as “regular job”), in a list. Through this print job list display screen 500, the user is able to cancel execution of print jobs, change the order of execution of print jobs, and so on.

As shown in FIG. 6, print job list display screen 500 displays information of the print jobs having been received in the MFP 200, in a list. The print jobs that are displayed in a list are stored in the memory 202 of the MFP 200. Among the information of print jobs, the information of the variable print job is provided in a layered structure, which is formed with upper layer information 510, which is information related to the variable print job, and lower layer information 511, which is formed with information of a plurality of sub-jobs which are obtained by classifying the information of the variable print job based on the variable data. The upper layer information 510 of the variable print job is placed in the same layer with information 520, 530 and 540 of the regular jobs.

In the print job list display screen 500 of the present embodiment, an icon 571, which indicates that the print job is a variable print job, is attached to the upper layer information 510 of the variable print job, so as to allow the user to identify between the upper layer information 510 of the variable print job and the information 520, 530 and 540 of the regular jobs in a folded state (which will be described later). Note that, unlike the present embodiment, upper layer information of a variable print job may be displayed in a different background color from that of information of a regular job, to distinguish between the variable print job and the regular job.

Information 510, 520, 530 and 540 of print jobs displayed on the print job list display screen 500 include job ID information, job name information, printing setting information, and status information. The job ID information is information for identifying a print job, and the job name information is information to show the name of the print job. The printing setting information is information to show the printing settings of a print job, and the status information is information to show the status of the print job. The printing setting information and status information will be described later in detail.

Referring to FIG. 6, information of the variable print job designated by the job ID “100001” is classified into four sub-jobs based on “client name,” and is provided in a layered structure of upper layer information 510, which is information related to the variable print job, and lower layer information 511, which is formed with information of the four sub-jobs. Also, the upper layer information 510 of the variable print job designated by the job ID “100001” is placed in the same layer with information 520 to 540 of the regular jobs designated by the job IDs “100002” to “100004.”

Also, as shown in FIG. 7, the print job list display screen 500 of the present embodiment is able to display the upper layer information 510 alone, without displaying the lower layer information 511 of the variable print job. The print job list display screen 500 is configured to be able to switch between the open state in which the lower layer information 511 of the variable print job is displayed with the upper layer information 510, and the folded state in which the upper layer information 510 is displayed without displaying the lower layer information 511. Note that, in FIG. 6, a “−” icon 572 is displayed to indicate that information of the variable print job can be folded, and, in FIG. 7, a “+” icon 573 is displayed to indicate that information of the variable print job can be opened up.

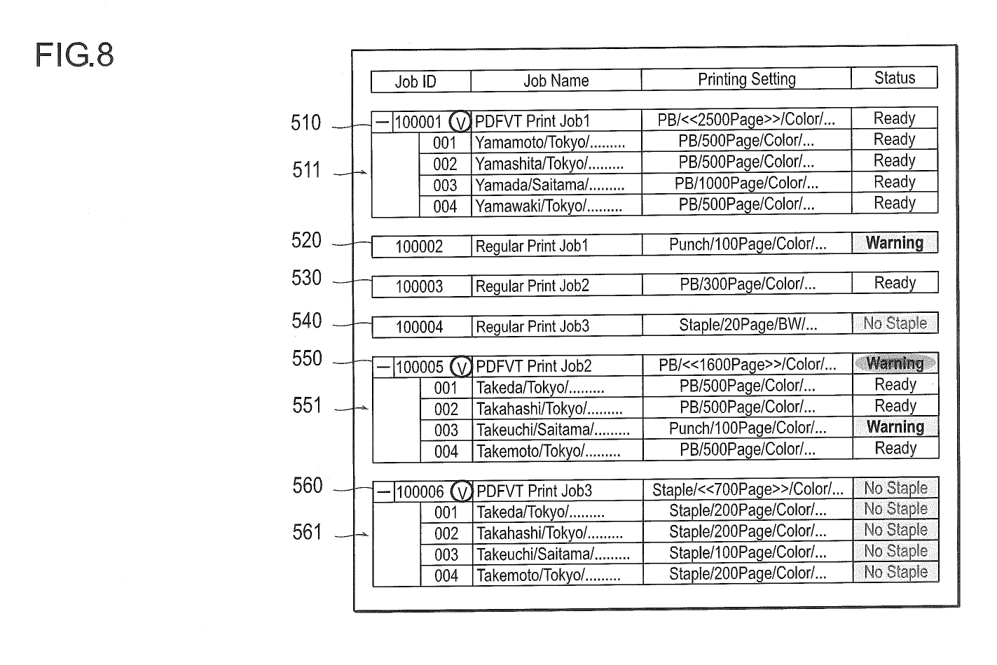

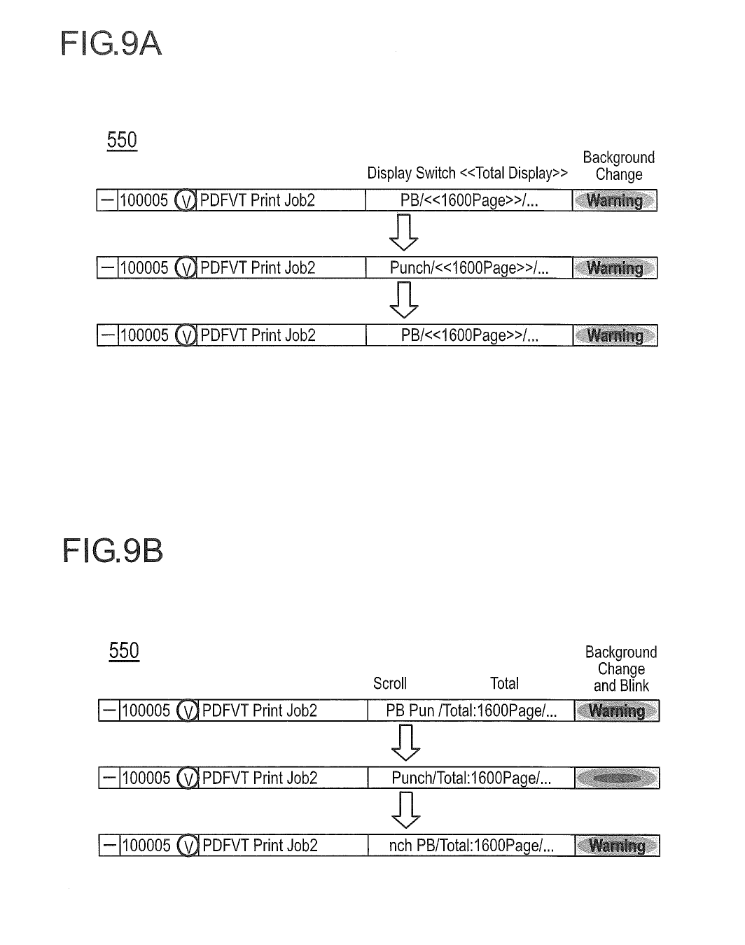

FIG. 8 is a view for explaining a state in which all information of the variable print job displayed on a print job list display screen is opened up, and FIG. 9A and FIG. 9B are partial enlarged views of FIG. 8.

As described above, information of variable print jobs displayed on the print job list display screen 500 is provided in a layered structure including upper layer information 510, 550, 560, which is information related to the variable print jobs, and lower layer information 511, 551, 561, which is formed with information of a plurality of sub-jobs.

As shown in FIG. 8, the lower layer information 511, 551 and 561 of the variable print jobs include the ID information, variable data information, printing setting information, and status information for each sub-job. The ID information is information for identifying a sub-job, and the variable data information is information to represent the variable data of the sub-job. Also, the printing setting information is information to represent the printing settings of a sub-job, and corresponds to the information of the job ticket 414 of the print data 400. The printing setting information includes information such as post-processing information, which shows the content of post-processing, page-number information which shows the number of pages to print, and color information which indicates color printing. The status information is information to show the status of a sub-job, and is defined by the printing setting information and the situation regarding the consumables of the MFP 200. The status information includes values such as “Ready,” “Warning” and “No Staple.” Then, the upper layer information 510, 550 and 560 of the variable print jobs includes information that corresponds to the lower layer information 511, 551 and 561.

In FIG. 8, referring to the printing setting information included in the lower layer information 561 of the variable print job designated by the job ID “100006,” it is clear that a stapling process (“Staple”) and color printing are designated for each sub-job. Also, among the four sub-jobs, as for the jobs of the job IDs “001,” “002” and “004,” the number of pages to print is 200 pages, and, as for the job of the job ID “003,” the number of pages to print is 100 pages. Note that such variation of the number of pages in variable printing arises from, for example, differences in fixed data to be used and differences in the page layout method to be designated. Also, referring to the status information of each sub-job, it is clear “No Staple” is displayed, which is information to indicate that the staples have run out in the MFP 200 and the sub-jobs cannot be executed.

Then, the upper layer information 560 of the variable print job designated by the job ID “100006” includes information to indicate that a stapling process and color printing are designated, and information to show the total number of pages to print for the sub-jobs. Also, the upper layer information 560 includes “No Staple,” which is information to indicate that the staples have run out and the sub-jobs cannot be executed.

Also, in FIG. 8, referring to the printing setting information included in the lower layer information 551 of the variable print job designated by the job ID “100005,” it is clear that a perfect binding process (“PB”: Perfect Binding) is designated with respect to the sub-jobs of the job IDs “001,” “002” and “004,” and that a punching process (“Punch”) is designated with respect to the sub-job of the job ID “003.” Also, referring to the status information, with respect to the sub-jobs of the job IDs “001,” “002” and “004,” “Ready” is displayed, which is information to indicate that a perfect binding process can be carried out without problems, and, with respect to the sub-job of the job ID “003,” “Warning” is displayed, which is information to indicate that the chad is nearly full in the MFP 200 and there is a possibility that the punching process cannot be carried out.

Then, the upper layer information 550 of the variable print job designated by the job ID “100005” includes both “Punch” and “PB.” As shown in FIG. 9A, “Punch” and “PB” are displayed alternately on the print job list display screen 500. Also, the upper layer information 550 includes “Warning,” which has the higher priority between “Warning” and “Ready,” and therefore “Warning” is displayed on the print job list display screen 500. Then, even in a state in which the lower layer information 551 is not displayed, the background color of “Warning” is changed, so that the user is able to recognize that a value other than “Warning” (that is, “Ready”) is included in the status information of sub-jobs.

Note that, unlike the present embodiment, as shown in FIG. 9B, it is equally possible to display “Punch” and “PB” in auto-scroll mode and display “Warning” to blink. Alternately, it is equally possible to display a dedicated icon without changing the background color or display method of “Warning.”

Also, information to be displayed on the print job list display screen 500 is not limited to those given in the above-described embodiment, and it is equally possible to display, for example, RIP-complete page number information, which shows the number of pages having been subjected to RIP, and information about the input trays and output trays, and so on. In the event the lower layer information of a variable print job includes RIP-complete page number information, the upper layer information then includes information to show the total number of pages having been subjected to RIP.

Likewise, the display method is also not limited by the above-described embodiment, and, when, for example, the values of information of sub-jobs vary between sub-jobs, for example, “ . . . ” may be displayed, which indicates that there are a plurality of post-processing, or a plurality of values may be displayed in auto-scroll mode, instead of “Warning,” which has high priority.

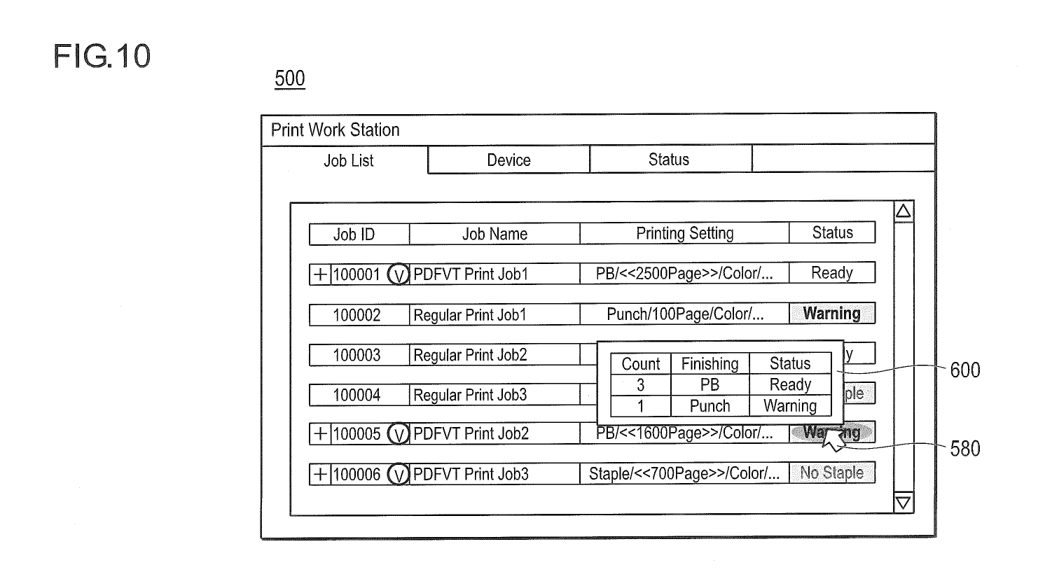

FIG. 10 is a view showing an example of a display screen in the event status information that is included in lower layer information of a variable print job is displayed in a popup on a display screen.

As shown in FIG. 10, in the print job list display screen 500 of the present embodiment, if a cursor 580 is moved to on the status information of upper layer information 550 of a variable print job in a state where the lower layer information is not displayed, a status information display screen 600 is displayed in a popup. The status information display screen 600 displays the content of the post-processing designated for the sub-jobs and the corresponding status information. According to this structure, the user is able to know the status information of sub-job without having lower layer information displayed.

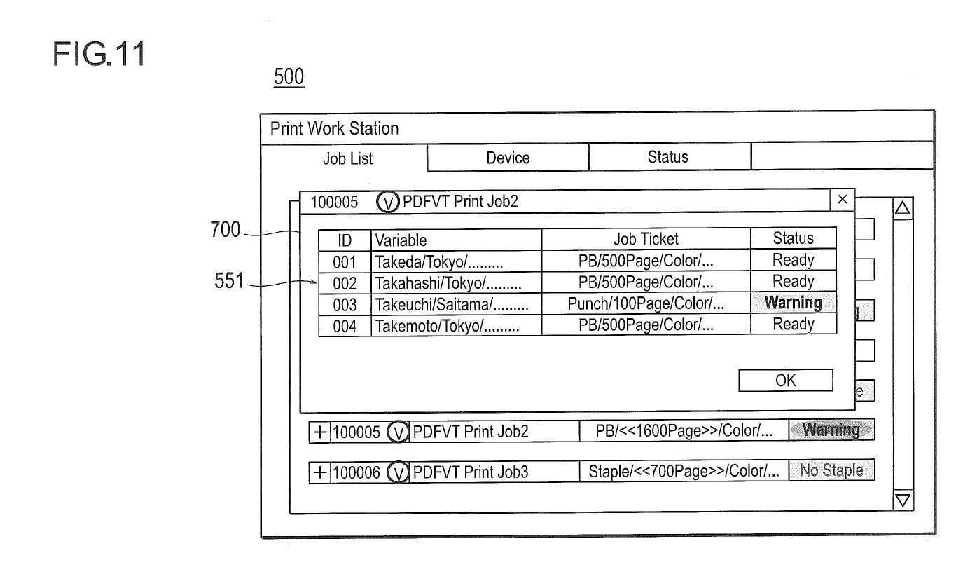

FIG. 11 is a view showing an example of a display screen in the event lower layer information of a variable print job is displayed on a separate screen. In the print job list display screen 500 of the present embodiment, if, for example, there is an input such as a double-click in a state in which a variable print job is designated by a cursor, a sub-job information display screen 700 is displayed. The sub-job information display screen 700 displays the lower layer information 551 of the variable print job.

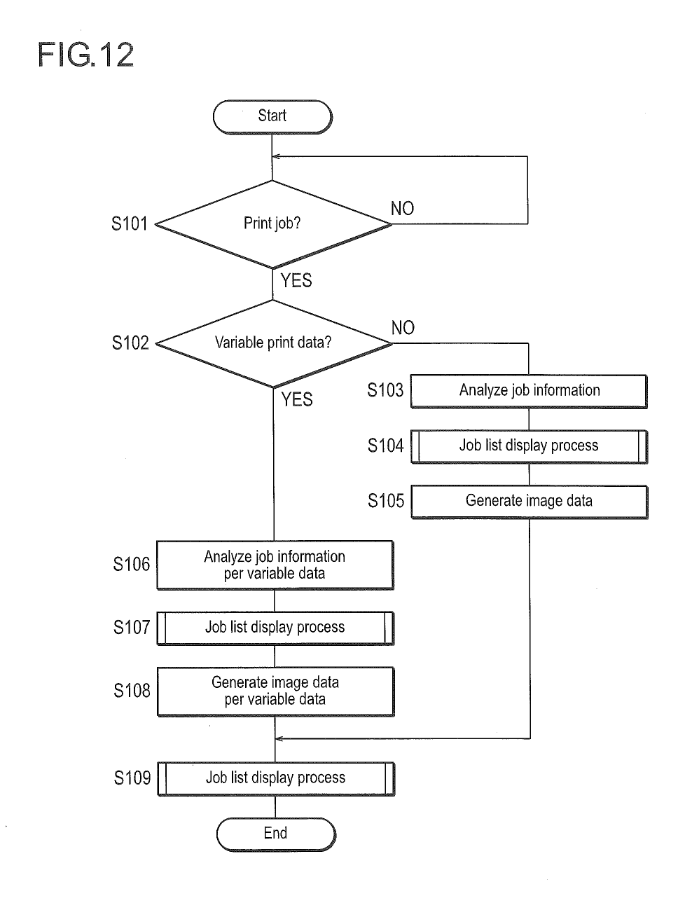

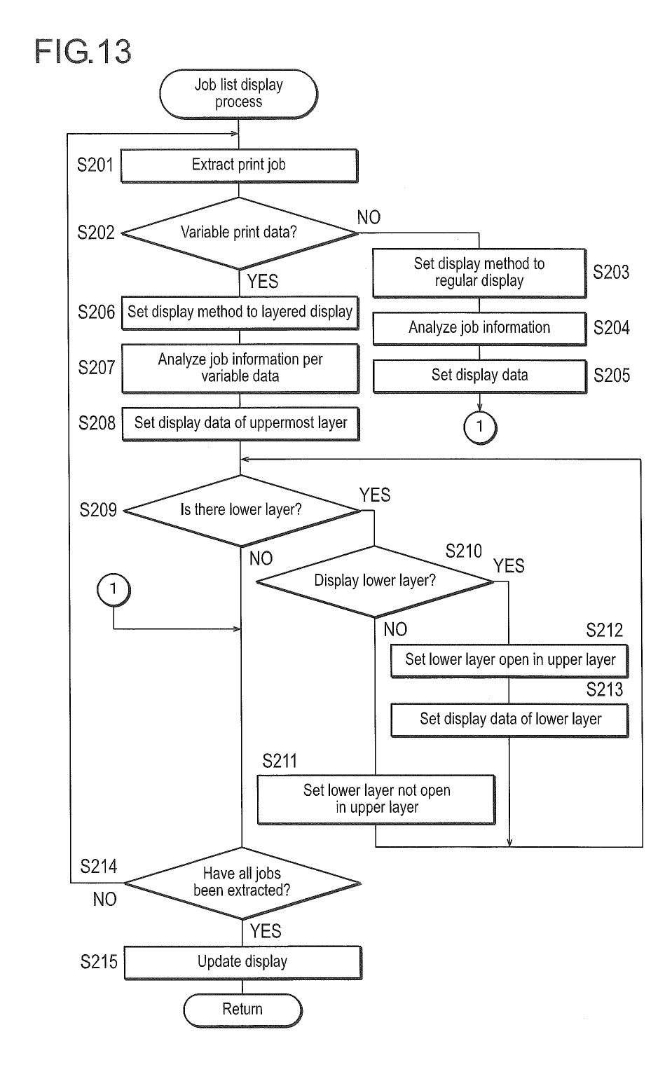

Next, the operation of the MFP 200 to display the print job list display screen 500 on the operation panel unit 220 will be described with reference to FIG. 12 and FIG. 13.

FIG. 12 is a flowchart showing the steps of a printing process executed by the MFP. Note that the algorithms shown in the flowchart of FIG. 12 are stored in the HDD 203 of the MFP 200 in the form of a program and executed by the CPU 201.

First, whether or not a print job has been received is determined (step S101). In the present embodiment, whether or not a print job is received from a PC on the network 300 is determined. In the event it is determined that a print job has not been received (step S101: “NO”), a print job is waited to be received.

On the other hand, in the event it is determined that a print job has been received (step S101: “YES”), whether or not the print job is a variable print job is determined (step S102). In the present embodiment, whether or not the print data of the print job acknowledged to have been received in the process shown in step S101 is variable print data, is determined.

In the event this print job is determined not to be a variable print job (step S102: “NO”), based on the assumption that the print job is a regular job, the job information is analyzed (step S103). In the present embodiment, information of the print job which is acknowledged in the process shown in step S101 to have been received is analyzed, in order to perform a regular printing process based on a regular job.

Next, a job list display process is executed (step S104). In the present embodiment, job list display process to display print job which MFP 200 has received in a list is executed. By execution of this job list display process, the print job list display screen 500 shown in FIG. 6 is displayed on the operation panel unit 220. The job list display process shown in step S104 will be described later in detail.

Next, image data is generated (step S105). In the present embodiment, in order to perform the printing process, image data is generated in bitmap format, based on the job information analyzed in the process shown in step S103. The image data in bitmap format is transmitted to the image forming unit 250.

On the other hand, if, in the process shown in step S102, the print job is determined to be a variable print job (step S102: “YES”), the job information is analyzed invariable data units (step S106). In the present embodiment, information of the print job which is acknowledged in the process shown in step S101 to have been received is analyzed in variable data units, in order to perform a variable printing process based on a variable print job.

Next, the job list display process is executed (step S107). By execution of the job list display process, the print job list display screen 500 shown in FIG. 6 is displayed on the operation panel unit 220.

Next, image data is generated on a per variable data basis (step S108). In the present embodiment, in order to perform the variable printing process, image data in bitmap format is generated in variable data units, based on the job information analyzed in the process shown in step S106. The image data in bitmap format is transmitted to the image forming unit 250. In the image forming unit 250, variable printing is executed in variable data units.

Then, job list display process is executed (step S109). By executing the job list display process again, the print job list display screen 500 is updated, and the situation as to the progress of the print job is reflected. To be more specific, for example, information of a print job that has been executed is removed from the print job list display screen 500. Alternately, in the event a sub-job of a variable print job has been finished, the corresponding status information of sub-job is changed to “Complete.”

As described above, according to the processes of the flowchart shown in FIG. 12, in the event a print job is received, the print job is executed, and the print job list display screen 500 to show a list of the print jobs having been received in the MFP 200, is displayed on the operation panel unit 220. Then, accompanying the execution of the print job, the print job list display screen 500 is updated.

Note that, in the present embodiment, the print job list display screen 500 is updated after the job information analysis process and the image data generation process. However, unlike the present embodiment, the print job list display screen 500 may be updated in the event necessity arises to change the display content on the print job list display screen 500 due to change in, for example, the printing situation and the state of the image forming unit 250, or when, for example, a print job is imported, compiled, removed or selected.

FIG. 13 is a flowchart showing the steps of the job list display process shown in steps S104, S107 and S109 in FIG. 12.

First, one print job is extracted (step S201). In the present embodiment, from a plurality of print jobs stored in the memory 202, one print job is extracted as an analysis-target print job.

Next, whether or not the print job is a variable print job is determined (step S202). In the event the print job is determined to be a variable print job (step S202: “YES”), the step moves on to the process of step S206.

On the other hand, in the event the print job is determined not to be a variable print job (step S202: “NO”), based on the assumption that the print job is a regular job, the job display method is set to regular display (step S203). By this setting of the job display method to regular display, a regular job is displayed distinguishably from a variable print job on the print job list display screen 500.

Next, the job information is analyzed (step S204). In the present embodiment, information of the print job extracted in the process shown in step S201 is analyzed in order to generate display information. Note that the job information analysis process shown in step S204 may be omitted. In this case, the analysis result of the job information analysis process shown in step S103 in FIG. 12 is used.

Then, the display data is set (step S205), and then the step moves on to the process of step S214. In the present embodiment, the data for display information is set based on the job information analyzed in the process shown in step S204. The display information includes, for example, job ID information, job name information, printing setting information and status information.

On the other hand, if, in the process shown in step S202, the print job is determined to be a variable print job (step S202: “YES”), the job display method is set to layered display (step S206). By this setting of the job display method to layered display, a variable print job is displayed distinguishably from a regular job on the print job list display screen 500.

Next, the job information is analyzed in variable data units (step S207). In the present embodiment, in order to display the variable print job in layered display, information of the print job is analyzed in variable data units. Note that the job information analysis process shown in step S207 may be omitted. In this case, the analysis result of the job information analysis process shown in step S106 in FIG. 12 is used.

Next, the display data of the uppermost layer is set (step S208). In the present embodiment, based on the job information analyzed in the process shown in step S207, the data for display information of the upper layer of the variable print job that is placed in the same layer with information of regular job, is set. The display information includes, for example, job ID information and job name information. Also, the display information includes information corresponding to printing setting information, information about the number of pages to print and status information, included in the lower layer information.

Next, whether or not there is a lower layer is determined (step S209). If it is determined that there is no lower layer (step S209: “NO”), the step moves on to the process of step S214.

On the other hand, in the event it is determined that there is a lower layer (step S209: “YES”), whether or not to display the lower layer is determined (step S210). In the present embodiment, based on the information that is set in advance, whether to display lower layer information with upper layer information or display upper layer information without displaying lower layer information, is determined.

If it is determined not to display the lower layer (step S210: “NO”), “LOWER LAYER NOT OPEN” is set in the upper layer (step S211), and the step returns to the process of step S209. In the present embodiment, “LOWER LAYER NOT OPEN” is set so that a “+” icon is displayed in the upper layer and the lower layer is displayed folded.

On the other hand, if it is determined to display the lower layer (step S210: “YES”), “LOWER LAYER OPEN” is set in the upper layer (step S212). In the present embodiment, “LOWER LAYER OPEN” is set so that a “−” icon is displayed in the upper layer and the lower layer is displayed.

Then, the display data of the lower layer is set (step S213), and the step returns to the process of step S209. The display information includes, for example, the ID information, variable data information, printing setting information, information about the number of pages to print, and status information for each sub-job.

On the other hand, if, in the process shown in step S209, it is determined that there is no lower layer (step S209: “NO”), whether or not all jobs have been extracted is determined (step S214). In the present embodiment, whether or not all of the print jobs stored in the memory 202 of the MFP 200 have been extracted is determined.

If it is determined not all jobs have been extracted (step S214 “NO”), the step returns to the process of step S201. As a result of this, the processes of and after step S201 are repeated until all print jobs are extracted.

On the other hand, if it is determined that all print jobs have been extracted (step S214: “YES”), the display content is updated (step S215), and the process is finished. As a result of this, the print job list display screen 500 shown in FIG. 6 is displayed.

As described above, according to the processes of the flowchart shown in FIG. 13, information of a variable print job is provided in a layered structure and is displayed with information of a regular job in a list.

By means of this structure, when information of the variable print job and information of the regular job are displayed in a list on the print job list display screen 500, the user is able to easily identify the information of the variable print job.

Also, according to the print job list display screen 500 of the present embodiment, a variable print job which has a plurality of job ticket settings is displayed in a comprehensible manner, so that the user is able to know and manage the overall situation of print jobs. As a result of this, user friendliness improves.

The present invention is by no means limited to the embodiment described above and can be changed in various ways within the scope of the claims.

For example, according to the above-described embodiment, information of a variable print job is classified based on variable data. However, it is equally possible to classify information of a variable print job based on the job ticket setting of the variable data. Also, information of a variable print job may be provided in a layered structure of three or more layers. For example, information of the variable print job that is classified based on the job ticket setting may be further classified based on the variable data and displayed in a three-stage layered structure.

Also, a case has been described with the above-described embodiment where the print job display apparatus of the present invention is applied to an MFP. However, it is equally possible to apply the print job display apparatus of the present invention to a printer controller that is separated from a printer or to a printer with a built-in printer controller. Alternately, the print job display apparatus of the present invention may be applied to a PC that is connected with an MFP via a network.

The units and method to perform various processes in the print job display apparatus according to the present embodiment may be implemented by either dedicated hardware circuits or a programmed computer. The program may be provided by means of, for example, a computer readable recording mediums such as a flexible disk or CD-ROM, or may be provided online via a network such as the Internet. In this case, the program that is recorded in the computer readable recording medium is transferred to a memory unit such as a hard disk and stored therein. Also, the program may be provided as single application software or may be incorporated as one function of a print job display apparatus in the software of this apparatus.

What is claimed is:

1. A non-transitory computer readable recording medium stored with a print job display program, said program causing a computer to execute a process comprising:
(a) identifying a print job designating variable printing, in which printing is carried out while replacing part of printing content; and
(b) displaying, on a display screen in a list, information related to said print job, to which information related to a plurality of sub-jobs obtained by classifying the information of said print job identified in step (a) based on predetermined classification information is attached as lower layer information, with information related to a print job not designating variable printing.

2. The non-transitory computer readable recording medium as claimed in claim 1, wherein
said display screen is configured to be able to switch between an open state in which said information related to the sub-jobs is displayed with said information related to the print job designating variable printing, and a folded state in which said information related to the sub-jobs is not displayed and said information related to the print job designating variable printing is displayed.

3. The non-transitory computer readable recording medium as claimed in claim 1, wherein
said information related to the sub-jobs includes status information to show a status of said sub-jobs, and
said display screen displays said status information for each of the plurality of sub-jobs in a list.

4. The non-transitory computer readable recording medium as claimed in claim 1, wherein
said information related to the sub-jobs includes printing setting information to represent printing setting set for said sub-jobs, and
said display screen displays said printing setting information for each of the plurality of sub-jobs in a list.

5. The non-transitory computer readable recording medium as claimed in claim 1, wherein
said information related to the print job designating variable printing includes information that corresponds to said information related to the sub-jobs, and
said display screen displays said information corresponding to said information related to the sub-jobs in association with identification information of said print job designating variable printing.

6. The non-transitory computer readable recording medium as claimed in claim 5, wherein
in an event where values of said information related to the sub-jobs vary between the plurality of sub-jobs, said information related to the print job designating variable printing includes at least one of said values that vary between the sub-jobs, and
said display screen displays said at least one value.

7. The non-transitory computer readable recording medium as claimed in claim 6, wherein
information for letting a user know that the values of said information related to the sub-jobs vary between the plurality of sub-jobs is added to said information related to the print job designating variable printing, and
said display screen displays said information for letting the user know that the values vary between the plurality of sub-jobs.

8. The non-transitory computer readable recording medium as claimed in claim 1, wherein
said information related to the sub-jobs includes print page-number information to represent the number of pages to print for the sub-jobs, and said information related to the print job designating variable printing includes total page-number information to represent a total number of pages to print for the plurality of sub-jobs, and
said display screen displays said print page-number information for each of the plurality of sub-jobs in a list, and displays said total page-number information in association with identification information of said print job designating variable printing.

9. The non-transitory computer readable recording medium as claimed in claim 1, wherein said process further comprises:
(c) in an event said information related to the sub-jobs is not displayed and said information related to the print job designating variable printing is displayed on said display screen, displaying said information related to the sub-jobs on a separate screen according to an operation by a user.

10. The non-transitory computer readable recording medium as claimed in claim 1, wherein
said information related to the print job not designating variable printing includes same information as said information related to the sub-jobs, and
said display screen displays said same information in association with identification information of said print job not designating variable printing.

11. A print job display apparatus, comprising:
an identification unit that identifies a print job designating variable printing, in which printing is carried out while replacing part of printing content; and
a display control unit that displays, on a display screen in a list, information related to said print job, to which information related to a plurality of sub-jobs obtained by classifying the information of said print job identified by said identification unit based on predetermined classification information is attached as lower layer information, with information related to a print job not designating variable printing.

12. The print job display apparatus as claimed in claim 11, wherein
said display screen is configured to be able to switch between an open state in which said information related to the sub-jobs is displayed with said information related to the print job designating variable printing, and a folded state in which said information related to the sub-jobs is not displayed and said information related to the print job designating variable printing is displayed.

13. The print job display apparatus as claimed in claim 11, wherein
said information related to the sub-jobs includes status information to show a status of said sub-jobs, and
said display screen displays said status information for each of the plurality of sub-jobs in a list.

14. The print job display apparatus as claimed in claim 11, wherein
said information related to the sub-jobs includes printing setting information to represent printing setting set for said sub-jobs, and
said display screen displays said printing setting information for each of the plurality of sub-jobs in a list.

15. The print job display apparatus as claimed in claim 11, wherein
said information related to the print job designating variable printing includes information that corresponds to said information related to the sub-jobs, and
said display screen displays said information corresponding to said information related to the sub-jobs in association with identification information of said print job designating variable printing.

16. The print job display apparatus as claimed in claim 15, wherein
in an event where values of said information related to the sub-jobs vary between the plurality of sub-jobs, said information related to the print job designating variable printing includes at least one of said values that vary between the sub-jobs, and
said display screen displays said at least one value.

17. The print job display apparatus as claimed in claim 16, wherein
information for letting a user know that the values of said information related to the sub-jobs vary between the plurality of sub-jobs is added to said information related to the print job designating variable printing, and
said display screen displays said information for letting the user know that the values vary between the plurality of sub-jobs.

18. The print job display apparatus as claimed in claim 11, wherein
said information related to the sub-jobs includes print page-number information to represent the number of pages to print for the sub-jobs, and said information related to the print job designating variable printing includes total page-number information to represent a total number of pages to print for the plurality of sub-jobs, and
said display screen displays said print page-number information for each of the plurality of sub-jobs in a list, and displays said total page-number information in association with identification information of said print job designating variable printing.

19. The print job display apparatus as claimed in claim 11, further comprising:
a screen display unit that, in an event said information related to the sub-jobs is not displayed and said information related to the print job designating variable printing is displayed on said display screen, displays said information related to the sub-jobs on a separate screen according to an operation by a user.

20. The print job display apparatus as claimed in claim 11, wherein
said information related to the print job not designating variable printing includes same information as said information related to the sub-jobs, and
said display screen displays said same information in association with identification information of said print job not designating variable printing.
